(19) United States
(12) Patent Application Publication
(10) Pub. No.: US 2015/0340005 A1
(43) Pub. Date: Nov. 26, 2015

(54) DISPLAY METHOD OF DISPLAY DEVICE AND DISPLAY DEVICE

(71) Applicants: BOE TECHNOLOGY GROUP CO., LTD., Beijing (CN); BEIJING BOE VISION-ELECTRONIC TECHNOLOGY CO., LTD., Beijing (CN)

(72) Inventors: Chun Che LAI, Beijing (CN); Chia Hung CHEN, Beijing (CN)

(21) Appl. No.: 14/375,373

(22) PCT Filed: Oct. 12, 2013
(86) PCT No.: PCT/CN2013/085125

§ 371 Date: Jul. 29, 2014

(30) Foreign Application Priority Data
Jun. 24, 2013 (CN) 201310253672.9

(51) Int. Cl. G09G 5/00

(52) U.S. Cl. CPC G09G 5/005; G09G 5/006; G09G 2340/0407

(57) ABSTRACT

There is disclosed a display method of a display device and the display device for implementing the display method. The display method includes: frequency-doubling converting a display signal when the display device determines that a scanning frequency of the display signal inputted to the display device is lower than a set threshold; and outputting the frequency-doubling converted display signal. The display output effect of the display device can be improved with the technical solutions of the present disclosure, so as to enhance user's experience.

### TECHNICAL FIELD

The present disclosure relates to the field of display technique, in particular to a display method of a display device and the display device.

### BACKGROUND

At present, a display device typically supports only an image frequency lower than 75 Hz. In general, a vertical frequency supported by the display device is 55 Hz˜76 Hz. In this state, a problem of image sticking will occur when an image is viewed using the display device. Such image sticking phenomenon is virtually caused because a frame rate of a display signal is too low; however, if a higher frame rate is provided, a general display device does not support the frame rate and thus a phenomenon of displaying out of range will occur. Generally, the phenomenon of a dynamic image sticking can be evidently ameliorated when the image frequency supported by the display device reaches 120 Hz. However, it is a pity that there is currently no display device supporting an image with a higher frequency.

### SUMMARY

In view of this, the present disclosure provides a display method of a display device and the display device, which can support an input of an image with a higher frequency or low frequency and can display an image with a high frequency.

In order to solve a technical problem existing in the prior art, embodiments of the present disclosure provides following technical solutions.

A display method of a display device comprises:

frequency-doubling converting a display signal when the display device determines that a scanning frequency of the display signal inputted to the display device is lower than a set threshold, and outputting the frequency-doubling converted display signal.

Optionally, the set threshold is 75 Hz or lower than 75 Hz.

Optionally, the set threshold is 72 Hz.

Optionally, the display device determines that a scanning frequency of the display signal inputted to the display device is lower than a set threshold, comprising:

determining that the scanning frequency of the display signal inputted to the display device is lower than the set threshold when the display device determines that only one set of differential signal interfaces of the display device is actuated;

determining that the scanning frequency of the display signal inputted to the display device is higher than the set threshold when the display device determines that more than two sets of differential signal interfaces of the display device are actuated; wherein the display device outputs the display signal without performing a frequency conversion on the display signal.

Optionally, the method further comprises:

converting a resolution of the display signal into a resolution supported by the display device when frequency-doubling converting the display signal.

A display device comprises:

a receiving unit for receiving a display signal;

a determining unit for determining whether or not a scanning frequency of the display signal is lower than a set threshold, and triggering a converting unit when it is YES;

a converting unit for frequency-doubling converting the display signal; and

an output unit for outputting the frequency-doubling converted display signal.

Optionally, the set threshold is 75 Hz or lower than 75 Hz.

Optionally, the set threshold is 72 Hz.

Optionally, the determining unit can be configured to determine that the scanning frequency of the display signal is lower than the set threshold when it is determined that only one set of differential signal interfaces of the display device is actuated;

the determining unit can be configured to determine that the scanning frequency of the display signal is higher than the set threshold when it is determined that more than two sets of differential signal interfaces of the display device are actuated; wherein the output unit directly outputs the display signal without performing a frequency conversion on the display signal by the converting unit.

Optionally, the converting unit is further configured to convert a resolution of the display signal into a resolution supported by the display device when frequency-doubling converting the display signal.

In the embodiments of the present disclosure, the frequency-doubling conversion is performed on the display signal when the display device determines that the scanning frequency of the display signal inputted to the display device is lower than the set threshold, and the frequency-doubling converted display signal is outputted by the display device. The set threshold is 75 Hz or lower than 75 Hz. Alternatively, the set threshold is 72 Hz. The display device can frequency-doubling converting a low-frequency image after receiving an image with a scanning frequency lower than 75 Hz, and then output the frequency-doubling converted image; however, after receiving an image with a scanning frequency of 120 HZ, the display device directly outputs the image without frequency-doubling converting the image. As such, by adopting the technical solutions provided in the embodiments of the present disclosure, a display output effect of the display device can be improved, thereby enhancing user's experience.

### BRIEF DESCRIPTION OF THE DRAWINGS

FIG. 1 is a schematic diagram of a component structure of a display device according to an embodiment of the present disclosure;

FIG. 2 is a flow diagram of a display method of a display device according to an embodiment of the present disclosure.

### DESCRIBING OF REFERENCE NUMERALS

10: receiving unit, 11: determining unit, 12: converting unit, 13: output unit.

### DETAILED DESCRIPTION

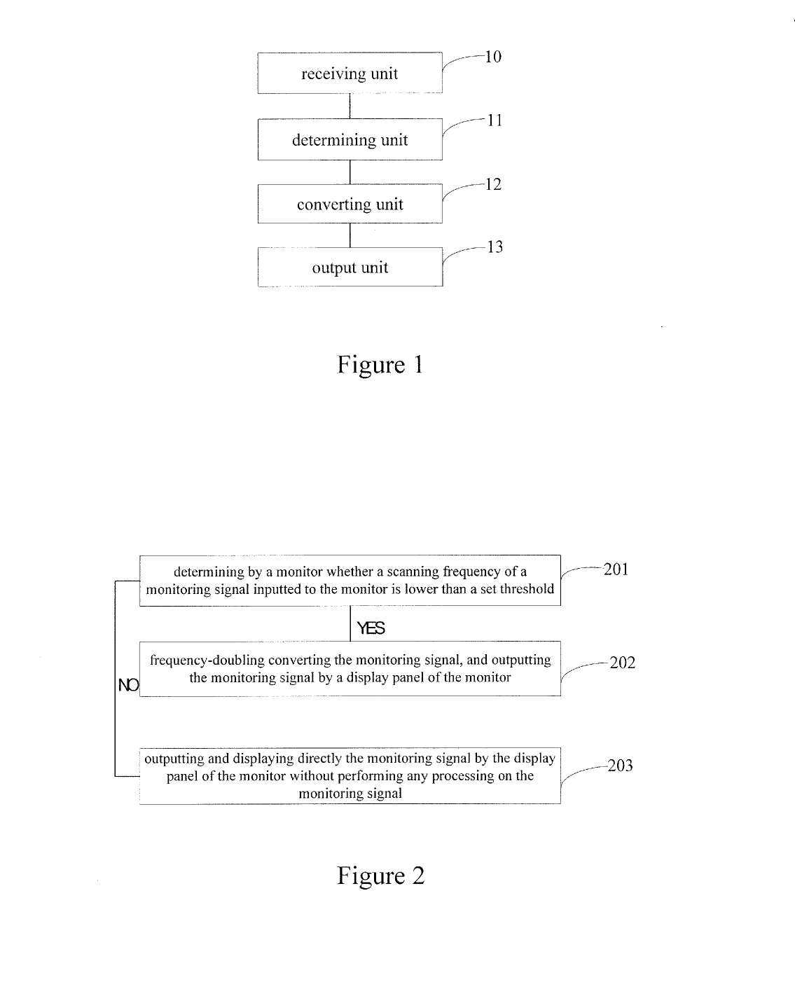

FIG. 1 is a schematic diagram of a component structure of a display device according to an embodiment of the present disclosure. As shown in FIG. 1, the display device of the present embodiment comprises a receiving unit 10, a determining unit 11, a converting unit 12 and an output unit 13.

The receiving unit 10 receives a display signal. The receiving unit 10 can be an audio/video input interface set on the display device. As such, the receiving unit 10 can realize receipt of the input display signal.

The determining unit 11 determines whether or not a scanning frequency of the display signal is lower than a set threshold, and triggers the converting unit 12 when it is YES. In general, the scanning frequency of the display signal is 55 Hz˜76 Hz, and the display device per se can determine the scanning frequency of the display signal by its display signal input interface. In particular, it is determined that the scanning frequency of the display signal is lower than the set threshold when it is determined that only one set of differential signal interfaces of the display device is actuated; it is determined that the scanning frequency of the display signal is higher than the set threshold when it is determined that more than two sets of differential signal interfaces of the display device are actuated; and correspondingly, the output unit 13 directly outputs the display signal without performing a frequency-doubling conversion on the display signal by the converting unit 12.

In particular, a pin interface of the display device has the following two specifications, as shown in Tables 1 and 2 below:

TABLE 1

| | | | | | | | | | | | | | | | |
|---|---|---|---|---|---|---|---|---|---|---|---|---|---|---|---|
| 1 | RX2− | 2 | RX2+ | 3 | SHLD2 | 4 | NC | 5 | NC | 6 | SCL | 7 | SDA | 8 | NC |
| 9 | RX1− | 10 | RX1+ | 11 | SHLD1 | 12 | NC | 13 | NC | 14 | 5 V | 15 | GND | 16 | SENSE |
| 17 | RX0− | 18 | RX0+ | 19 | SHLD0 | 20 | NC | 21 | NC | 22 | SHLDC | 23 | RXC+ | 24 | RXC− |

TABLE 2

| | | | | | | | | | | | | | | | |
|---|---|---|---|---|---|---|---|---|---|---|---|---|---|---|---|
| 1 | RX2− | 2 | RX2+ | 3 | SHLD2 | 4 | 2RX1− | 5 | 2RX1+ | 6 | SCL | 7 | SDA | 8 | NC |
| 9 | RX1− | 10 | RX1+ | 11 | SHLD1 | 12 | 2RX0− | 13 | 2RX0+ | 14 | 5 V | 15 | GND | 16 | SENSE |
| 17 | RX0− | 18 | RX0+ | 19 | SHLD0 | 20 | 2RX2− | 21 | 2RX2+ | 22 | SHLDC | 23 | RXC+ | 24 | RXC− |

In Table 1, there is only one set of input interfaces of the display signal, i.e., RX0−RX0+/RX1−RX1+/RX2−RX2+; the input interface of the display signal is a differential signal interface; however, while in Table 2, there are two sets of input interfaces of the display signal, i.e., two sets of RX0−RX0+/RX1−RX1+/RX2−RX2+. When the two sets of differential signal interfaces of the display device with the specification as show in Table 2 are both actuated, it is indicated that the display signal currently inputted to the display device is a high-frequency signal. Since the display device supports a high frequency, the display signal at this time can be directly displayed and outputted by a display panel of the display device such as Panel without performing a frequency-doubling conversion by the converting unit 12, while the display device with the specification as shown in Table 1 only supports an input of one path of display signal, and the frequency of one path of display signal is 55 Hz˜76 Hz, and thus it is needed for the display signal to be displayed and outputted by the display panel of the display device such as Panel after a frequency-doubling processing is performed by the converting unit 12. When the display device with the specification as shown in Table 2 has only one set of differential signal interfaces actuated, it is indicated that only one path of display signal is inputted and the frequency of one channel of display signal is 55 Hz˜76 Hz, and thus it is needed for the display signal to be displayed and outputted by the display device after a frequency-doubling processing is performed by the converting unit 12. When the high-frequency display signal is outputted from the display panel of the display device, the phenomenon of image sticking will not occur, thereby improving the display output effect of the display device and enhancing user's experience.

In the present embodiment, the determining unit 11 is implemented by a liquid crystal control chip, scaler, i.e., determining through the scaler whether the display device actuates a Dual link mode, i.e., determining whether two sets of differential signal interfaces are actuated, to determine the currently input display signal is a high-frequency display signal or a low-frequency display signal, so as to determine whether the frequency-doubling processing is performed on the input display signal.

In the present embodiment, the frequency of the input display signal can be directly detected to determine a specific frequency value of the display signal, and the obtained specific frequency value of the display signal is used to determine whether it is needed to perform the frequency-doubling processing on the display signal.

The converting unit 12 is configured to perform the frequency-doubling conversion on the display signal. The converting unit 12 can be implemented by a frame rate converter.

The output unit 13 is configured to output and display the frequency-doubling converted display signal. The output unit 13 supports a 120 Hz video signal, and may be a display panel such as Panel.

In the embodiment of the present disclosure, the set threshold is 75 Hz or lower than 75 Hz. Optionally, the set threshold is 72 Hz. In general, for a display panel supporting an output of a 120 Hz video signal, when the frequency of the input display signal is more than 72 Hz, after the frequency-doubling processing is performed, a phenomenon of going beyond the display scope will occur when the display panel outputs the display video signal. Therefore, the frequency of the video signal of the input display device is in general not more than 72 Hz.

In the present embodiment, the converting unit 12 is further configured to convert a resolution of the display signal into a resolution supported by the display device when the frequency-doubling conversion is performed on the display signal.

In the present embodiment, the display device may be a display having a display panel and so on. For example, the display device of the present embodiment can be any products or means having a display function such as a liquid crystal panel, an electronic paper, an OLED panel, a liquid crystal TV set, a liquid crystal display, a digital photo frame, a mobile phone and a tablet computer and the like.

In the present embodiment, the resolution supported by the display panel of the display device is 1920×1080 while the resolution of the input low-frequency display signal is 800×600. As a result, when a frequency conversion is performed on the display signal, it is needed to correspondingly convert the resolution of the display signal when the resolution of the real signal is not 1920×1080, for example, it is needed for the display signal to be outputted and displayed by the display panel of the display device after the resolution 800×600 of the input display signal is converted into the resolution 1920×1080 supported by the display panel of the display device.

Those skilled in the art shall understand that the implemented functions of respective processing units as shown in FIG. 1 can be realized by programs ran on the processor or can be realized by a particular logic circuit.

When performing data processing, the above processing unit needs to store the processed display signal in a corresponding storage, for example, after receiving the display signal, the receiving unit 10 firstly stores the display signal in the storage of the display device, and then the determining unit 11 obtains the display signal from the corresponding storage when it needs to process the display signal. The storage may also be a buffer or a memory of the display device. Since storing the display signal is a common technique, unnecessary implementation details are herein not given thereto.

The solution of fundamentally solving the image sticking phenomenon of the display device in the present embodiment improves the image sticking phenomenon by raising the display specification of the input terminal and the output terminal, i.e., by using a 120 Hz display panel and performing the frequency-doubling processing on the low-frequency video signal.

The display device of the present embodiment not only supports a high-frequency (120 Hz) monitoring signal but also has compatibility with a general low-frequency (55 Hz˜76 Hz) monitoring signal.

FIG. 2 is a flow diagram of a display method of a display device according to an embodiment of the present disclosure. As shown in FIG. 2, the display method of the display device in the present embodiment comprises following steps:

Step 201: determining by the display device whether a scanning frequency of the display signal of the display device is lower than a set threshold; and performing step 202 when it is YES; otherwise, performing step 203.

A set threshold is 75 Hz or lower than 75 Hz. Optionally, the set threshold is 72 Hz.

In general, the scanning frequency of the display signal is 55 Hz˜76 Hz, and the display device per se can determine the scanning frequency of the display signal by its display signal input interface. In particular, it is determined that the scanning frequency of the display signal is lower than the set threshold when it is determined that only one set of differential signal interfaces of the display device is actuated; it is determined that the scanning frequency of the display signal is higher than the set threshold when it is determined that more than two sets of differential signal interfaces of the display device are actuated.

Step 202: performing a frequency-doubling conversion on the display signal, and outputting and displaying the display signal by a display panel of the display device.

In the present embodiment, a video signal frequency supported by the display panel of the display device is 120 Hz. When a frequency of a display signal inputted to the display device is 55 Hz˜76 Hz, the display signal cannot be outputted and displayed by the display panel of the display device until a corresponding frequency-doubling processing is performed.

Step 203: directly outputting and displaying the display signal by the display panel of the display device without performing the frequency conversion on the display signal.

When it is determined that the frequency of the display signal inputted to the display device is higher than the set threshold, the display signal is directly displayed and outputted by the display panel of the display device without performing a frequency-doubling processing on the display signal.

In the present embodiment, before the display panel of the display device displays and outputs the display signal, there further comprises: adjusting a resolution of the display signal into a resolution supported by the display panel when it is determined that the resolution of the display signal mismatches with the resolution supported by the display panel.

In the present embodiment, the resolution supported by the display panel of the display device is 1920×1080 while the resolution of the low-frequency display signal inputted to the display device is 800×600. As a result, it is needed to correspondingly convert the resolution of the display signal, that is, the display signal is not outputted and displayed by the display panel of the display device until the resolution 800×600 of the input display signal is converted into the resolution 1920×1080 supported by the display panel of the display device.

The method of the present embodiment not only supports a high-frequency (120 Hz) monitoring signal but also has compatibility with a general low-frequency (55 Hz˜76 Hz) monitoring signal.

The above descriptions are just exemplary embodiments of the present disclosure rather than being used for limiting the protection scope of the present disclosure. Those skilled in the art can make various improvements and modifications to the embodiments of the present disclosure without departing from the spirit and scope of the present disclosure. The protection scope of the present disclosure shall be subject to the protection scope of the Claims.

1. A display method of a display device, comprising steps of:
frequency-doubling converting a display signal when the display device determines that a scanning frequency of the display signal inputted to the display device is lower than a set threshold; and
outputting the frequency-doubling converted display signal.

2. The display method according to claim 1, wherein the set threshold is 75 Hz or lower than 75 Hz.

3. The display method according to claim 1, wherein the set threshold is 72 Hz.

4. The display method according to claim 1, wherein the display device determines that a scanning frequency of the display signal inputted to the display device is lower than a set threshold, comprising:
determining that the scanning frequency of the display signal inputted to the display device is lower than the set threshold when the display device determines that only one set of differential signal interfaces of the display device is actuated;
determining that the scanning frequency of the display signal inputted to the display device is higher than the set threshold when the display device determines that more than two sets of differential signal interfaces of the display device are actuated;
wherein the display device outputs the display signal without performing a frequency conversion on the display signal.

5. The display method according to claim 1, further comprising:
converting a resolution of the display signal into a resolution supported by the display device when frequency-doubling converting the display signal.

6. A display device, comprising: a receiving unit, a determining unit, a converting unit and an output unit, wherein:
the receiving unit receives a display signal;
the determining unit determines whether a scanning frequency of the display signal is lower than a set threshold and triggers the converting unit when it is YES;
the converting unit frequency-doubling converts the display signal; and
the output unit outputs the frequency-doubling converted display signal.

7. The display device according to claim 6, wherein the set threshold is 75 Hz or lower than 75 Hz.

8. The display device according to claim 6, wherein the set threshold is 72 Hz.

9. The display device according to claim 6, wherein the determining unit is configured to determine that the scanning frequency of the display signal is lower than a set threshold when it is determined that only one set of differential signal interfaces of the display device is actuated;
the determining unit is configured to determine that the scanning frequency of the display signal is higher than the set threshold when it is determined that more than two sets of differential signal interfaces of the display device are actuated;
wherein the output unit directly outputs the display signal without performing a frequency conversion on the display signal by the converting unit.

10. The display device according to claim 6, wherein the converting unit is further configured to convert a resolution of the display signal into a resolution supported by the display device when frequency-doubling converting the display signal.

11. The display method according to claim 2, wherein the set threshold is 72 Hz.

12. The display method according to claim 2, wherein the display device determines that a scanning frequency of the display signal inputted to the display device is lower than a set threshold, comprising:
determining that the scanning frequency of the display signal inputted to the display device is lower than the set threshold when the display device determines that only one set of differential signal interfaces of the display device is actuated;
determining that the scanning frequency of the display signal inputted to the display device is higher than the set threshold when the display device determines that more than two sets of differential signal interfaces of the display device are actuated;
wherein the display device outputs the display signal without performing a frequency conversion on the display signal.

13. The display method according to claim 3, wherein the display device determines that a scanning frequency of the display signal inputted to the display device is lower than a set threshold, comprising:
determining that the scanning frequency of the display signal inputted to the display device is lower than the set threshold when the display device determines that only one set of differential signal interfaces of the display device is actuated;
determining that the scanning frequency of the display signal inputted to the display device is higher than the set threshold when the display device determines that more than two sets of differential signal interfaces of the display device are actuated;
wherein the display device outputs the display signal without performing a frequency conversion on the display signal.

14. The display method according to claim 2, further comprising:
converting a resolution of the display signal into a resolution supported by the display device when frequency-doubling converting the display signal.

15. The display method according to claim 3, further comprising:
converting a resolution of the display signal into a resolution supported by the display device when frequency-doubling converting the display signal.

16. The display device according to claim 7, wherein the set threshold is 72 Hz.

17. The display device according to claim 7, wherein the determining unit is configured to determine that the scanning frequency of the display signal is lower than a set threshold when it is determined that only one set of differential signal interfaces of the display device is actuated;
the determining unit is configured to determine that the scanning frequency of the display signal is higher than the set threshold when it is determined that more than two sets of differential signal interfaces of the display device are actuated;
wherein the output unit directly outputs the display signal without performing a frequency conversion on the display signal by the converting unit.

18. The display device according to claim 8, wherein the determining unit is configured to determine that the scanning frequency of the display signal is lower than a set threshold when it is determined that only one set of differential signal interfaces of the display device is actuated;
the determining unit is configured to determine that the scanning frequency of the display signal is higher than the set threshold when it is determined that more than two sets of differential signal interfaces of the display device are actuated;
wherein the output unit directly outputs the display signal without performing a frequency conversion on the display signal by the converting unit.

19. The display device according to claim 7, wherein the converting unit is further configured to convert a resolution of the display signal into a resolution supported by the display device when frequency-doubling converting the display signal.

20. The display device according to claim 8, wherein the converting unit is further configured to convert a resolution of the display signal into a resolution supported by the display device when frequency-doubling converting the display signal.
